(19) United States
(12) Patent Application Publication
(10) Pub. No.: US 2005/0073489 A1
(43) Pub. Date: Apr. 7, 2005

(54) LED drive circuit

(75) Inventors: Hiroshi Suzunaga, Kanagawa (JP); Kazuo Imanishi, Kanagawa (JP); Akihiro Kawano, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/866,699

(22) Filed: Jun. 15, 2004

(30) Foreign Application Priority Data
Oct. 3, 2003 (JP) 2003-345715

(51) Int. Cl. G09G 3/34

(52) U.S. Cl. 345/84

(57) ABSTRACT

An LED drive circuit according to an embodiment of the present invention comprises: a constant voltage source configured to supply a constant voltage; a current generating circuit configured to generate a current responsive to the impedance value of an impedance circuit connected to an external terminal, based upon the constant voltage supplied from the constant voltage source; and a current amplifying circuit configured to amplify the current generated by the current generating circuit to generate a drive current for driving LEDs.

### CROSS-REFERENCE TO RELATED APPLICATIONS

This application claims the benefit of priority under 35USC § 119 to Japanese Patent Application No. 2003-345715, filed on Oct. 3, 2003, the entire contents of which are incorporated herein by reference.

### BACKGROUND OF THE INVENTION

1. Field of the Invention

The present invention relates to an LED drive circuit for driving LEDs used as illuminator elements of a portable information device, or the like.

2. Related Background Art

Recently, lithium batteries have spread as easily handled and rechargeable batteries for portable devices. Along with developments of sophisticated portable devices powered by batteries, LEDs are often used for condition display and as backlight for liquid crystal displays. Especially, white LEDs are more often used together with development of color liquid crystal display. Generally, white LEDs comprise blue LEDs and fluorescent elements for converting blue light to green and red to produce white by mixing the light's three primary colors of red, blue and green.

In theory, blue LEDs need a voltage about 2.7 V or more to drive, and commercially available blue LEDs require a voltage of 3˜4 V. Therefore, to drive white LEDs on a device powered by a lithium ion battery having the discharge final voltage of 3.0, a booster circuits has been used for an LED-driving semiconductor device to compensate the shortage of the voltage.

In case of a portable telephone device consuming about 80% or more of the capacity of a lithium ion battery, it is necessary to drive it with a battery voltage not higher than 3.4 V. In case of typical white LEDs, they are generally driven by a current of or below about 20 mA in a temperature range of normal use to assure an acceptable lifetime of the LEDs. In case using a plurality of white LEDs, it is required that current of every white LEDs is controlled at or below 20 mA.

On this account, the amount of current to LEDs has been controlled as shown in FIG. 13 that shows a conventional LED drive device. More specifically, the output voltage of a lithium ion battery 101 of 3.2 V to 4.2 V is boosted to a constant voltage around 5 V with a booster/constant voltage circuit 102. This voltage is supplied to a serial connection of an LED 111 and a resistor 121, serial connection of an LED 112 and a resistor 122, serial connection of an LED 113 and a resistor 123, et seq., which are connected in parallel to the power source 101. Thereby, current of all LEDs 111, 112, 113, et seq., are adjusted to a constant value.

In this case, however, fluctuations of LEDs 111, 112, 113, et seq., in forward voltage characteristics largely fluctuate the current flowing into the respective LEDs, and hence largely fluctuate the luminance of the LEDs.

Also known is another conventional LED drive device configuration shown in FIG. 14. This LED drive device boosts the output voltage of lithium ion battery 101 of 3.2 V to 4.2 V with a booster/constant current circuit 103 and generates a constant current by using the output voltage of a resistor 104 to supply it to LEDs 111, 112, 113, et seq.

The conventional techniques shown in FIGS. 13 and 14, however, need a booster circuit such as a DC-DC converter for the booster/constant voltage circuit 102 or the booster/constant current 103.

Therefore, the conventional techniques had disadvantages in increasing the cost and in shortening the lifetime of the battery due to the use of a discharge current of the battery, which is larger than the current for driving the LEDs.

Moreover, the DC-DC converter used in the booster/constant voltage circuit 102 or booster/constant current circuit 103 generates high-frequency switching noise. Since the switching noise is liable to interfere the highly sensitive wireless receiver of the portable telephone and invite deterioration in sensitivity, the conventional techniques need a shield or other similar member and certain consideration on the circuit board design or structural design.

Furthermore, conventional techniques often get in trouble with audio frequencies and low-frequency noise as the return noise that is changed to audio frequencies in a AD converter used for converting transmission voice of the portable telephone to a digital form.

On this account, there is another scheme that does not raise the voltage when the battery voltage is high such as in note type personal computers, and instead connects the power source to LEDs to control the current of all LEDs with resistors. Nevertheless, this scheme again encountered the problem of large fluctuations of LEDs in luminance because of variances of LEDs in property and hence large fluctuations of the current flowing through LEDs.

To cope with it, it was proposed to use a constant current circuit for stabilization of the current in case the commercial alternating current or the like is usable and the source voltage is sufficiently high, as disclosed in Japanese Patent Laid-open Publications JP2003-59676A and JP-H11-305198A.

However, when the conventional technique disclosed in Japanese Patent Laid-open Publications JP2003-59676A and JP-H11-305198A are used for driving with a battery, it is disadvantageous in increasing the cost and the weight because of the need for an increased number of serially connected batteries to raise the source voltage.

To overcome this disadvantage, still another conventional LED drive device shown in FIG. 15 connects serially connected pairs of LEDs 111, 112, 113 114 et seq. and resistors 121, 122, 123, 124 et seq. to the power source 101 in parallel to control the current of all LEDs 111, 112, 113, 114 et seq. instead of increasing the battery voltage.

Nevertheless, this LED drive device still has the disadvantage of large fluctuations of the current of the LEDs 11, 112, 113, 114 et seq. because of variance of the forward voltage of LEDs and large fluctuations of the current depending upon the voltage of the battery 101.

Therefore, even when the battery is fully charged and ready to supply a sufficient voltage, it is necessary to increase the resistance to reduce fluctuations of luminance of the LEDs and to drive the LEDs with much lower current than the maximum rated value of expensive LEDs, i.e., under insufficient luminance.

Furthermore, this configuration must use a DC-DC converter or the like to change the luminance of LEDs, that is, to change the current to the LEDs, but the use of the DC-DC converter invites various inconveniences already discussed herein.

### SUMMARY OF THE INVENTION

An LED drive circuit according to an embodiment of the present invention comprises: a constant voltage source configured to supply a constant voltage; a current generating circuit configured to generate a current responsive to the impedance value of an impedance circuit connected to an external terminal, based upon the constant voltage supplied from the constant voltage source; and a current amplifying circuit configured to amplify the current generated by the current generating circuit to generate a drive current for driving LEDs.

### BRIEF DESCRIPTION OF THE DRAWINGS

FIG. 1 is a block diagram showing an arrangement of an LED drive system as an embodiment of the invention;

FIG. 2 is a diagram showing the arrangement of an LED drive circuit in the LED drive system in detail;

FIG. 3 is a diagram showing a circuit arrangement capable of changing the impedance value between the LED drive circuit (chip) and a predetermined reference potential;

FIG. 4 is a diagram showing another arrangement of the LED drive system;

FIG. 5 is a block diagram showing an arrangement of an LED drive system as another embodiment of the invention;

FIG. 6 is a diagram for explaining a dilating property;

FIG. 7 is a diagram showing an arrangement of a buffer circuit in the LED drive system shown in FIG. 5;

FIG. 8 is a diagram showing an arrangement of the buffer circuit in the LED drive system shown in FIG. 5;

FIG. 9 is a diagram showing an arrangement of the buffer circuit in the LED drive system shown in FIG. 5;

FIG. 10 is a diagram showing an arrangement of the buffer circuit in the LED drive system shown in FIG. 5;

FIG. 11 is a diagram showing an arrangement of the buffer circuit in the LED drive system shown in FIG. 5;

FIG. 12 is a schematic block diagram showing a configuration of an LED drive system as still another embodiment of the invention;

FIG. 13 is a diagram of an arrangement of a conventional LED drive circuit;

FIG. 14 is a diagram of an arrangement of another conventional LED drive circuit; and

FIG. 15 is a diagram of an arrangement of still another conventional LED drive circuit.

### DETAILED DESCRIPTION OF THE INVENTION

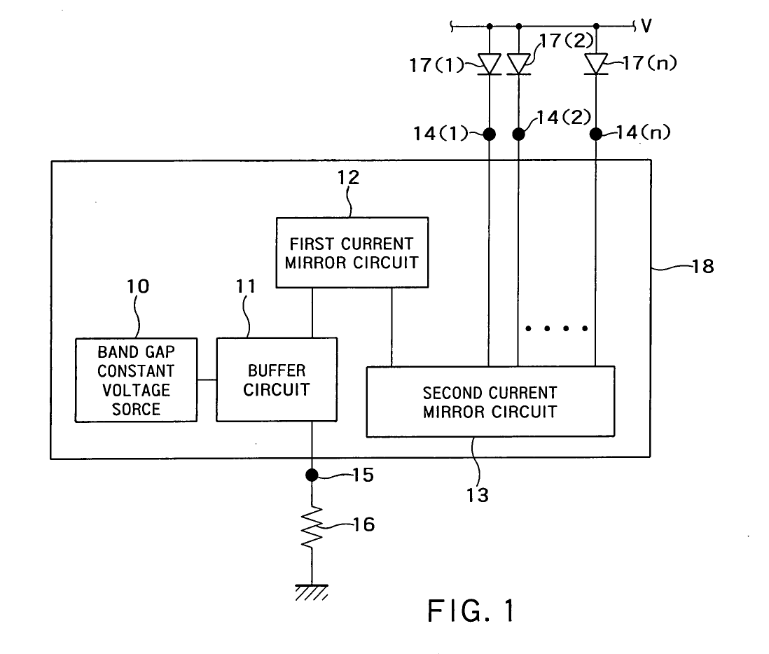

FIG. 1 is a block diagram showing an arrangement of an LED drive system as an embodiment of the invention.

The LED drive system shown here includes a plurality of LEDs 17(1)˜17(n), LED drive circuit 18 in form of one chip, for example, to drive the LEDs 17(1)˜17(n), and externally connected impedance circuit 16 that connects an external terminal (external current-setting terminal) 15 of the LED drive circuit 18 to a reference potential (such as ground potential). The system uses a lithium ion battery or a serial connection of two or three secondary batteries (not shown) as its power source. The LEDs 17(1)˜17(n) may be selected from various types of LEDs. In this system, white LEDs are used.

The LED drive circuit 18 and the LEDs 17(1)˜17(n) are connected via external terminals (current output terminals) 14(1)˜14(n).

A buffer circuit 11 in the LED drive circuit 18 generates a current based on the output voltage from a band gap constant voltage source connected thereto and the impedance value of an impedance circuit 16 connected thereto via the external current-setting terminal 15. A first current mirror circuit 12 amplifies the current supplied from the buffer circuit 11, and supplies it to a second current mirror circuit 13 connected thereto. The second current mirror circuit 13 again amplifies the current supplied from the first current mirror circuit 12 and supplies it to the LEDs 17(1)˜17(n) via the current output terminals 14(1)˜14(n). The LEDs 17(1)˜17(n) are driven by the current supplied from the second current mirror circuit 13.

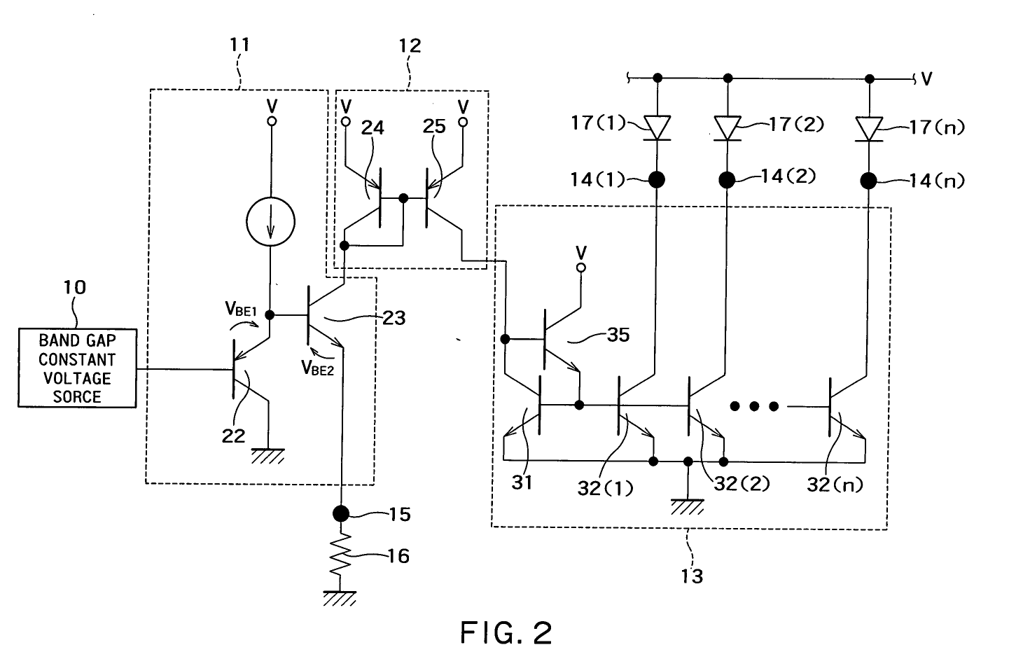

FIG. 2 is a diagram showing the arrangement of an LED drive circuit 18 in the LED drive system in greater detail.

As shown in FIG. 2, the buffer circuit 11 outputs a voltage approximately equal to the voltage supplied from the band gap constant voltage source 10 to the external current-setting terminal 15.

More specifically, the output voltage of the band gap constant voltage source 10 is increased by an amount corresponding to the base-emitter voltage V_{BE1} in a PNP transistor 22 having the collector connected to the reference potential and the emitter connected to the source voltage V via a load like a current source, for example. Then, this voltage is reduced by an amount corresponding to the base-emitter voltage V_{BE2} in an NPN transistor 23 having the base connected to the emitter of the PNP transistor 22, and then is outputted to the external current-setting terminal 15. The base-emitter voltage V_{BE1} of the PNP transistor 22 and the base-emitter voltage V_{BE2} of the NPN transistor 23 are approximately equal. Therefore, a voltage approximately equal to the output voltage of the band gap constant voltage source 10 is output to the external current-setting terminal 15.

A current determined by the voltage of the external current-setting terminal 15 and the impedance value of the impedance circuit 16 flows from the external current-setting terminal 15 to the reference potential. That is, a current equal to that current flows from a PNP transistor 24 composing the first current mirror circuit 12 to the collector of the NPN transistor 23, and this current is employed as the reference current of the first current mirror circuit 12. The emitter of the PNP transistor 24 is connected to the source potential V, and the collector of the PNP transistor 24 is connected to the collector of the NPN transistor 23.

Connected to the base of the PNP transistor 24 is the base of another PNP transistor 25. These bases are commonly connected to the collector of the PNP transistor 24. The PNP transistor 25 amplifies the reference current by a predetermined magnification (for example, to a double) and supplies it to the second current mirror circuit 13.

As apparent from the foregoing explanation, the buffer circuit 11 generates the reference current that is determined by the output voltage of the band gap constant voltage source 10 and the impedance value of the impedance circuit 16. In greater detail, the buffer circuit 11 generates the reference current determined by the voltage of the external current-setting terminal 15 and the impedance value of the impedance circuit 16. The first current mirror circuit 12 amplifies the reference current by a predetermined magnification, and supplies it to the second current mirror circuit 13.

The second current mirror circuit 13 includes a plurality of output transistors (NPN transistors) 32(1)˜32(n) associated with the LEDs 17(1)˜17(n) respectively to amplify the current from the first current mirror circuit 12 by a predetermined magnification (for example, 50 times) in the output transistors and supply the amplified currents to the associated LEDs 17(1)˜17(n). That is, if the amplifying magnification of the first current mirror circuit 12 is two times and the amplifying magnification of the second current mirror circuit 13 is 50 times, then a current as much as a hundred times (=2×50) of the reference current of the first current mirror circuit 12 is supplied to the respective LEDs 17(1)˜17(n).

In greater detail regarding the second current mirror circuit 13, the current output from the first current mirror circuit 12 flows into the collector of a reference current transistor (NPN transistor) 31 connected to the collector of the PNP transistor 25. The emitter of the reference current transistor 31 is connected to a predetermined reference potential. The current flowing into the collector of the reference current transistor 31 raises the base potential of the reference current transistor 31, and this potential is supplied to the output transistors 32(1)˜32(n) commonly connected to the base of the reference current transistor 31. Emitters of the output transistors 32(1)˜32(n) are connected to a predetermined reference potential, and their collectors are connected to the current output terminals 14(1)˜14(n). The output transistors 32(1)˜32(n) supplied with the base potential amplify the collector current of the current transistor 31 by a predetermined magnification (such as 50 times) and output the amplified current through respective current output terminals 34. That is, the output transistors 32(1)˜32(n) have an emitter area larger that that of the reference current transistor 31 by the predetermined magnification.

An NPN transistor 35 shown in FIG. 2 as having the base connected to the collector of the reference current transistor 31 and the emitter connected to the base of the transistor 31 is used to supply the base current to the output transistors 32(1)˜32(n). That is, this NPN transistor 35 prevents the collector current of the reference current transistor 31 from partly flowing to the base and reducing its amount, thereby the NPN transistor 35 prevents the effect of amplification from reducing. The collector of the NPN transistor 35 is connected to the source potential V.

The drive current of the LEDs 17(1)˜17(n) can be set freely by changing the impedance of the impedance circuit connected to the external current-setting terminal 15.

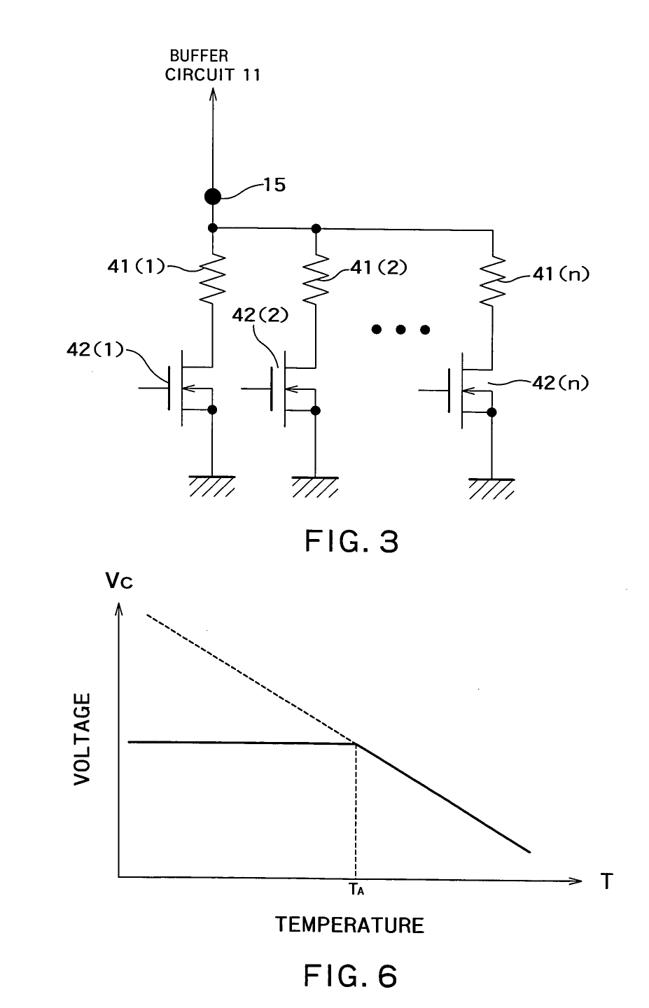

FIG. 3 shows another example of the impedance circuit 16. Here again, the current supplied to the LEDs 17(1)˜17(n) can be changed.

More specifically, as shown in FIG. 3, serial connections of resistors 41(1)˜41(n) and n-channel MOS transistors 42(1)˜42(n) are connected in parallel between the external current-setting terminal 15 and the predetermined reference potential. Any desired combination of the n-channel MOS transistors 42(1)˜42(n) may be turned on or off to change the impedance value between the external current-setting terminal 15 and the predetermined reference potential to set the drive current of the LEDs 17(1)˜17(n) to a desired value.

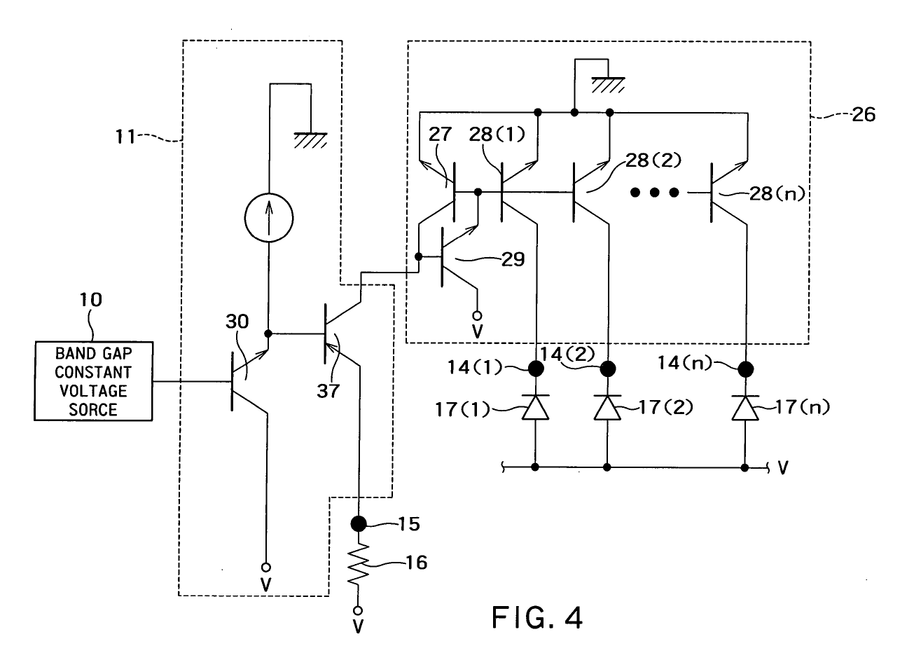

In the above-explained example, the current once amplified by the PNP transistor composing the first current mirror circuit 12 is again amplified by the NPN transistors composing the second current mirror circuit 13. However, as shown in FIG. 4 which shows another example of the LED drive system, in case the first-stage current mirror circuit 26 comprises NPN transistors 27, 28(1)˜28(n) and 29, the current mirror circuit 26 can directly output the current to the LEDs 17(1)˜17(n).

That is, in bipolar ICs, in general, NPN transistors exhibit better performance than PNP transistors. Therefore, if the current mirror circuit is composed of NPN transistors, a sufficient current can be supplied to the LEDs by the first-stage amplification. Thus, an efficient circuit arrangement reduced in circuit area is possible.

In this arrangement using NPN transistors 27, 28(1)˜28(n) and 29 to compose the current mirror circuit 26, a PNP transistor 37 or a P channel FET (not shown) is used as the transistor connected to one end of the impedance circuit 16, and the other end of the impedance circuit 16 is connected to the source potential. Further, an NPN transistor 30 is used as the transistor having the base for connection of the output of the band gap constant voltage source 10. Its collector is connected to the source potential, and the emitter is coupled to the reference potential.

As explained above, this embodiment is configured to generate the current corresponding to the impedance value of the impedance circuit based on the constant voltage supplied from the band gap constant voltage source and to drive the LEDs with a current amplified from the said current. Therefore, it is possible to supply the LEDs with a stable current and to change or modify the drive current of the LEDs by changing the impedance value of the impedance circuit in an appropriate manner such as switching resistors in the impedance circuit, for example.

Furthermore, the present embodiment is configured to supply the current to the LEDs instead of the conventional techniques using a booster circuit (charge pump circuit) and thereby raising the voltage from the power source. Therefore, the LED drive system according to the embodiment does not suffer various undesirable problems caused by the use of a booster circuit as discussed in conjunction with the prior techniques. That is, without high-frequency and low-frequency noise from such booster circuit, portable telephones and other devices having wireless receiver function, which are liable to be affected by noise, are enhanced in performance. Additionally, without the need of extracting a battery discharge current larger than the current for driving LEDs from the battery to such booster circuit, the battery of the device like a portable telephone can be used for a longer lifetime. Besides, omission of the expensive booster circuit contributes to reducing the cost.

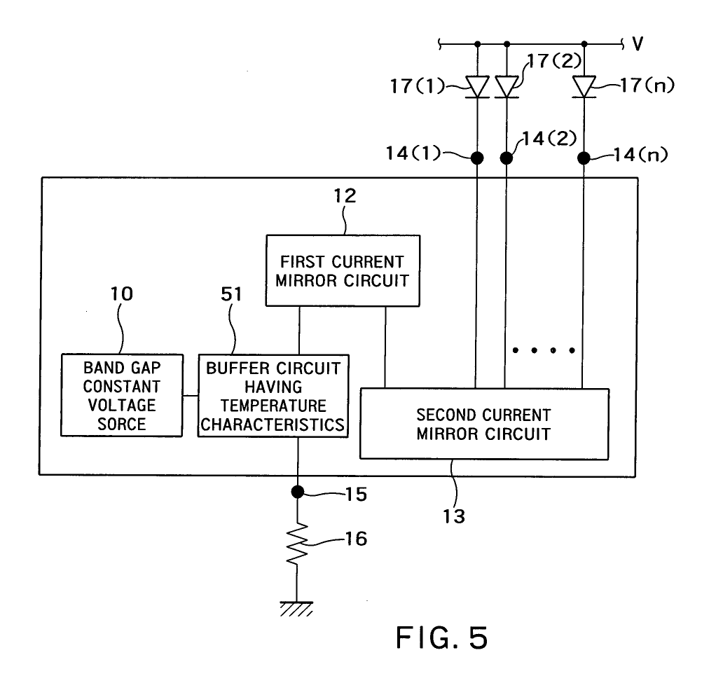

FIG. 5 is a block diagram showing an arrangement of an LED drive system as another embodiment of the invention.

This semiconductor device shown here has the additional function of controlling the current for driving LEDs depending upon the chip temperature (ambient temperature) as compared with the buffer circuit in the preceding embodiment. LEDs, in general, deteriorate earlier under high temperatures. To cope with this problem, the current flowing inside is limited under high temperatures to reduce the power consumption (dilating). The embodiment shown here has such a dilating function in the buffer circuit 51.

FIG. 6 is a graph showing exemplary dilating characteristics.

As shown by the solid line in FIG. 6, once the chip temperature exceeds a predetermined temperature T_{A}, the buffer circuit 51 decreases the voltage of the external current-setting terminal 15 and thereby reduces the current flowing into the impedance circuit 16. That is, the buffer circuit 51 reduces the current supplied to the LEDs 17(1)˜17(n). On the other hand, the buffer circuit 51 maintains the voltage in the external current-setting terminal 15 at a constant level up to the predetermined temperature Tₐ.

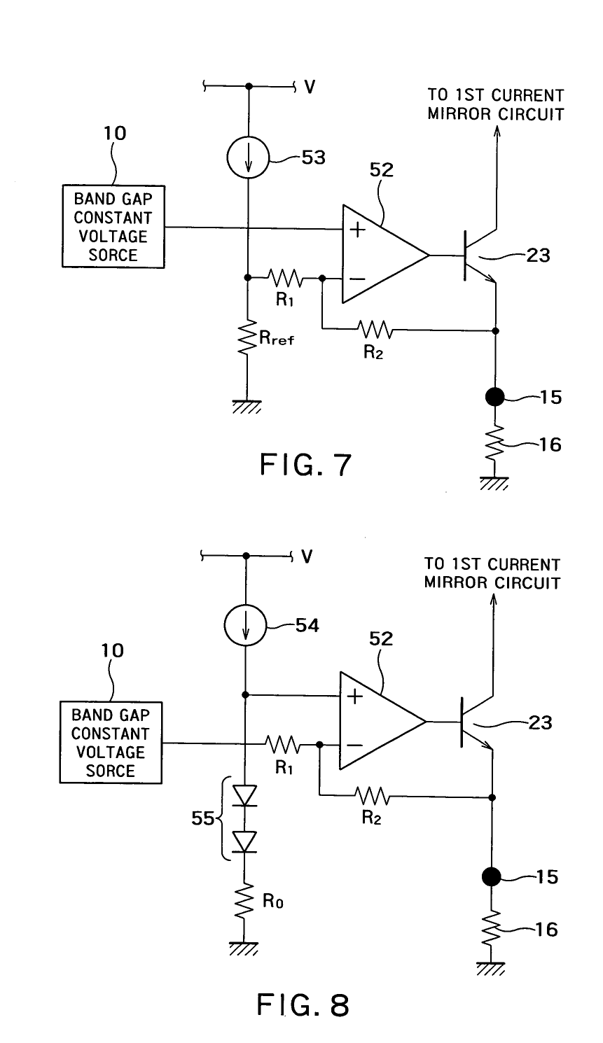

FIGS. 7 through 10 are diagrams showing some arrangements of the buffer circuit for changing the voltage in the external current-setting terminal 15 in accordance with changes of the chip temperature.

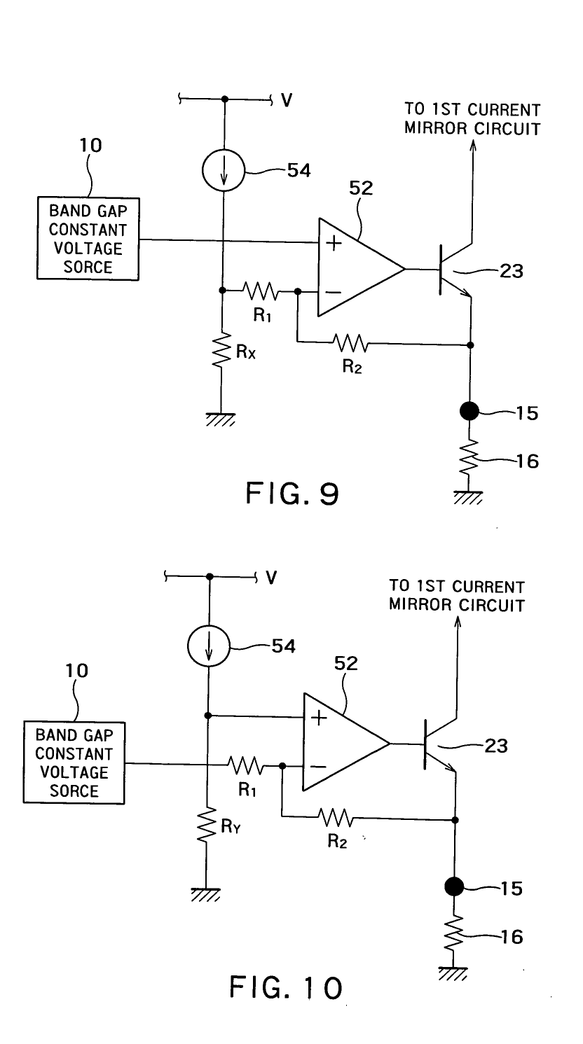

In greater detail, FIG. 7 shows an arrangement for controlling the voltage in the external current-setting terminal 15 by using a current source having a positive temperature coefficient. FIG. 8 shows an arrangement for controlling the voltage in the external current-setting terminal 15 by using a negative temperature coefficient the forward voltage V_{F} of a diode has. FIG. 9 shows an arrangement for controlling the voltage in the external current-setting terminal 15 by using a resistor having a positive temperature coefficient. FIG. 10 shows an arrangement for controlling the voltage in the external voltage-setting terminal 15 by using a resistor having a negative temperature coefficient.

First as shown in FIG. 7, in case a current source 53 having a positive temperature coefficient is used, the voltage in the external current-setting terminal 15 must have a negative coefficient with respect to the temperature. Therefore, the voltage of the band gap constant voltage source 10 is input to the plus terminal of a differential amplifier 52. In this circuit, once the chip temperature rises, output current of the current source 53 increases, and hence the voltage (output voltage) applied to the resistor Rref increases. As the voltage applied to the resistor Rref increases, the input voltage to the minus terminal of the differential amplifier 52 increases beyond the input voltage to the plus terminal. Therefore, the NPN transistor 23 operates in the direction reducing the output voltage. As a result, the current flowing in the impedance circuit 16 decreases, and the voltage of the external current-setting terminal 15 linearly decreases to a predetermined voltage. In FIG. 7, R₁ and R₂ are resistors for determining the rate of amplification of the differential amplifier 52, and the rate of amplification is determined by R₂/R₁. For example, when temperature coefficient of the output voltage of the resistor Rref is 1 mV/° C. and R₁/R₂=5, then the temperature coefficient of the external current-setting terminal 15 is 1 mV/° C.×−5=−5 mV/° C.

Next as shown in FIG. 8, in case a negative temperature coefficient of the forward voltage V_{F} of the diode 55 is used to control the voltage, the voltage of the band gap constant voltage source 10 is input to the minus terminal of the differential amplifier 52 to furnish the voltage of the external current-setting terminal 15 with a negative coefficient with respect to the temperature. Here is used the current source 54 having no temperature characteristics is used as the current source. R₀ is a voltage-adjusting resistance for equalizing the output voltage of the band gap constant voltage source 10 and the forward voltage of the diode 55. In this circuit, once the chip temperature rises, the forward voltage of the diode 55 lowers. Accordingly, the input voltage to the plus terminal of the differential amplifier 52 lowers below the input voltage to the minus terminal. The decrease of the input voltage to the plus terminal results in reducing the output current to the NPN transistor 23 and lowering the voltage of the external current-setting terminal 15.

Next as shown in FIG. 9, in case the resistor Rₓ having the positive temperature coefficient is used to control the voltage, the voltage of the band gap constant voltage source 10 is input to the plus terminal of the differential amplifier 52 similarly to the arrangement of FIG. 7 to furnish the voltage of the external current-setting terminal 15 with a negative coefficient with respect to the temperature. Here is used the current source 54 having no temperature characteristics as the current source In this circuit, once the chip temperature rises, the resistance value of the resistor R_{X} increases, and the input voltage to the minus terminal of the differential amplifier 52 becomes higher than the input voltage of the plus terminal. As a result, the out put current of the NPN transistor 23 decreases, and the voltage of the external current-setting terminal 15 lowers.

Next as shown in FIG. 10, in case the resistor R_{Y} having a negative temperature coefficient is used to control the voltage, the voltage of the band gap constant voltage source 10 is input to the minus terminal of the differential amplifier 52 similarly to the arrangement of FIG. 8 to furnish the voltage of the external current-setting terminal 15 with a negative coefficient with respect to the temperature. In this circuit, once the chip temperature rises, the resistance value of the resistor R_{Y} lowers, and the input voltage to the plus terminal of the differential amplifier 52 goes below the input voltage to the minus terminal. As a result, the output current of the NPN transistor 23 decreases, and the voltage of the external current-setting terminal 15 lowers.

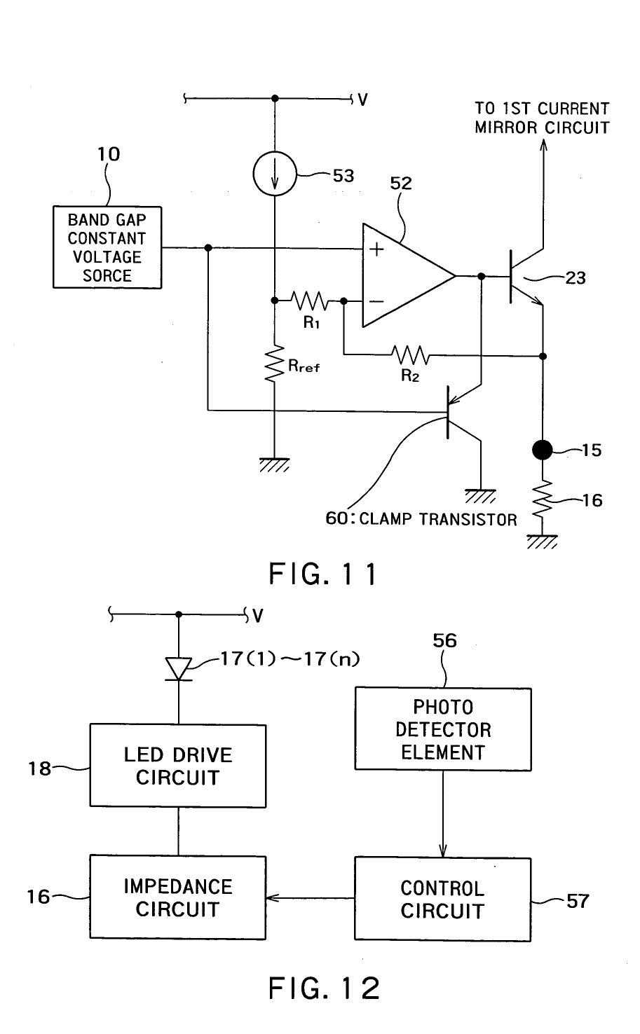

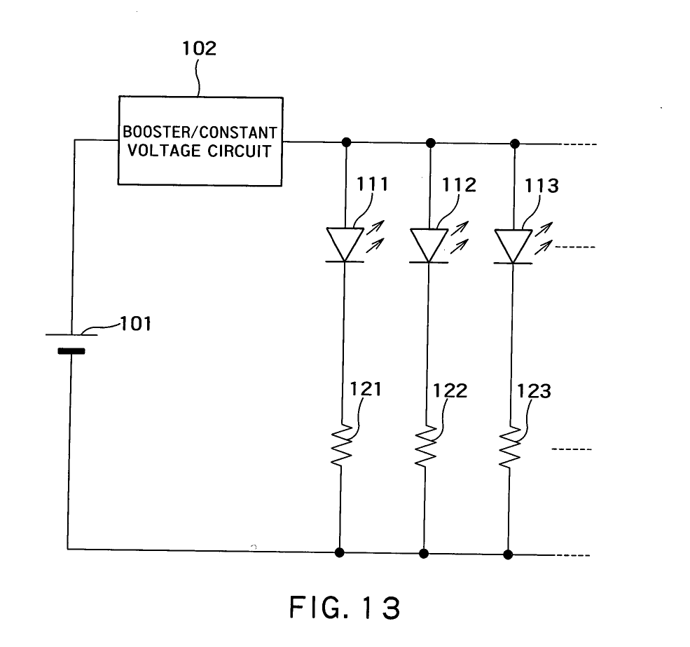

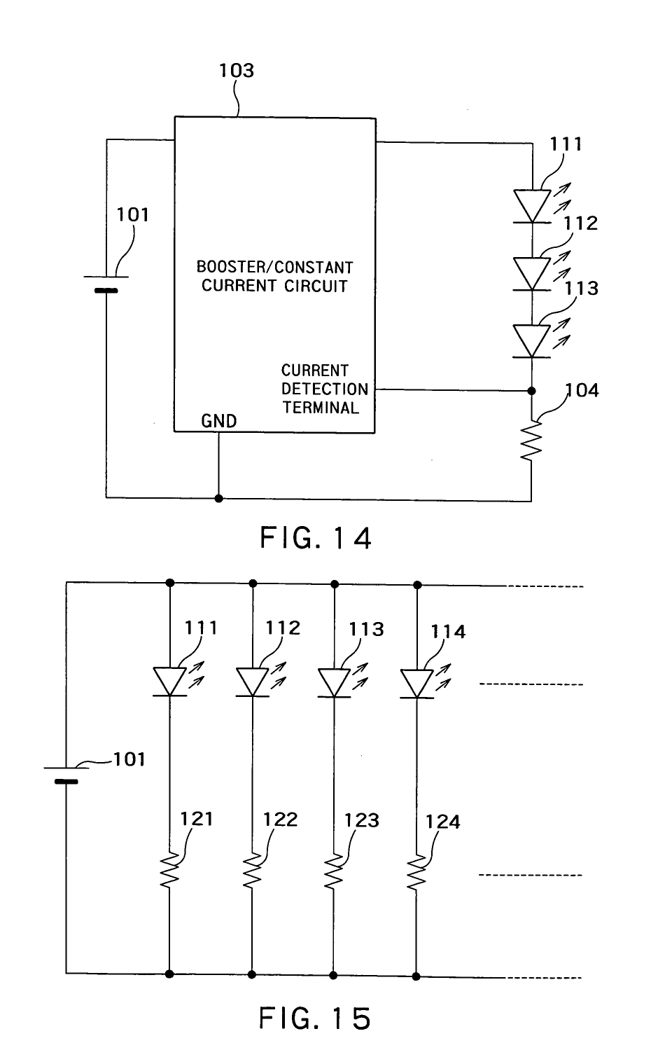

FIG. 11 is a diagram showing a circuit including the circuit of FIG. 7 and a clamp transistor 60 added to hold the voltage of the external current-setting terminal 15 at a constant level under temperatures equal to and lower than a predetermined degree (for example temperature T_{A}) (see FIG. 6). The voltage of the external current-setting terminal 15 can be held constant under the predetermined temperature or lower temperatures also in the circuit shown in FIGS. 8 through 10 by adding the clamp transistor 60 thereto. However, here is taken the circuit including the clamp transistor 60 added to circuit of FIG. 7 as a representative example.

As shown in FIG. 11, the emitter of the clamp transistor (PNP transistor) 60 is connected to the base of the NPN transistor 23, and the base is connected to the output of the band gap constant voltage source 10. The collector is connected to a predetermined reference potential. As understood also from the dilating characteristics of FIG. 6, the circuit of FIG. 7 not having the clamp transistor 60 cannot prevent the voltage of the external current-setting terminal 15 from rising in accordance with the decrease of the temperature even when the temperature is TA or lower (see the broken lines of FIG. 6). In case of the circuit of FIG. 11, however, the clamp transistor 60 clamps the base potential of the NPN transistor 23 at the predetermined temperature T_{A}, and thereby prevents the current of the external current-setting terminal 15 from increasing beyond it. That is, as the temperature decreases, the current from the current source 53 increases, and the circuit operates toward increasing the output voltage of the differential amplifier 52; however, since the emitter-base impedance of the clump transistor 60 decreases as the output voltage of the differential amplifier 52 increases, the output voltage of the differential amplifier 52 is prevented from increasing. As a result, at and below the predetermined temperature T_{A}, the voltage of the external current-setting terminal 15 is clamped approximately at the voltage of the band gap constant voltage source 10, and does not increase beyond the voltage. On the other hand, at or above the predetermined temperature T_{A}, since the diode between the emitter and the base of the clamp transistor 60 turns off, the circuit of FIG. 11 becomes equivalent to the circuit of FIG. 7, and the voltage of the external current-setting terminal 15 decreases along with the rise of the temperature.

As explained above, according to this embodiment, having the buffer circuit execute dilating of the power the LEDs can consume, can assure a longer lifetime of the LEDs.

FIG. 12 is a schematic block diagram showing an arrangement of an LED drive system as still another embodiment of the invention.

The LED drive system shown here includes a photo diode or other photo detector element 56 for detecting illumination, and a control circuit 57 for controlling the impedance value of the impedance circuit 16 in response to the detected illumination, in addition to any of LED drive systems according to the foregoing embodiments of the invention. More specifically, the LED drive system shown here controls the amount of light emitted by the LEDs 17(1)˜17(n) to meet with detected illumination by using the photo detector element 56 to detect illumination and using the control circuit 57 to control the impedance value of the impedance circuit 16 in accordance with the illumination. In this manner, the LED drive system effectively enhanced in efficiency of use of the battery can be realized. For example, when a portable telephone having this LED drive system is used in a dark place, the amount of light emitted from the LEDs 17(1)˜17(n) may be increased to light the display brighter. When the portable telephone is used in a bright place, the amount of light emitted from the LEDs 17(1)˜17(n) may be reduced to display representation of less illumination. Thereby, the LED drive system capable of efficient use of its battery can be realized.

The foregoing embodiments of the invention have been explained as using bipolar transistors to compose the buffer circuit 11, 51, first current mirror circuit 12, second current mirror circuit 13 and current mirror circuit 26. However, field effect transistors may be used in lieu of bipolar transistors. That is, NPN bipolar transistors can be replaced by N-channel MOS, and PNP bipolar transistors cab be replaced by P-channel MOS. The use of field effect transistors instead of bipolar transistors is advantageous in not requiring the base current compensation in the second current mirror circuit 13 (see the NPN transistor 35). However, since a fluctuation of the base-emitter voltage is small between NPN bipolar transistors and PNP bipolar transistors, in the case of using bipolar transistors, accuracy of current mirror circuit becomes higher, and thus accuracy of the voltage outputted to external current-setting terminal becomes also higher.

1. An LED drive circuit comprising:
a constant voltage source configured to supply a constant voltage;
a current generating circuit configured to generate a current responsive to the impedance value of an impedance circuit connected to an external terminal, based upon the constant voltage supplied from the constant voltage source; and
a current amplifying circuit configured to amplify the current generated by the current generating circuit to generate a drive current for driving LEDs.

2. The LED drive circuit according to claim 1 wherein the current amplifying circuit includes output transistors capable of connecting to the respective LEDs via output terminals to generate the drive current to the respective LEDs using the output transistors.

3. The LED drive circuit according to claim 1 wherein the current generating circuit has an NPN bipolar transistor whose base is supplied with the output of the constant voltage source, said external terminal being connected to the emitter of the NPN bipolar transistor, and said current amplifying circuit being connected to the collector of the NPN bipolar transistor.

4. The LED drive circuit according to claim 1 wherein the current generating circuit has a PNP bipolar transistor whose base is supplied with the output of the constant voltage source, and an NPN bipolar transistor whose base is connected to the emitter of the PNP bipolar transistor, said NPN bipolar transistor having the emitter connected to the external terminal and the collector connected to the current amplifying circuit.

5. The LED drive circuit according to claim 4 wherein the current amplifying circuit includes:
a first current mirror circuit including a plurality of PNP bipolar transistors which amplify the current flowing in the collector of the NPN bipolar transistor as reference current; and
a second current mirror circuit including a plurality of NPN bipolar transistor which amplify the output current of the first current mirror circuit as reference current to generate the drive current to the LEDs.

6. The LED drive circuit according to claim 1 wherein the current generating circuit has a PNP bipolar transistor whose base is supplied with the output of the constant voltage source, the emitter of the PNP bipolar transistor being connected to the external terminal, and the collector of the PNP bipolar transistor being connected to the current amplifying circuit.

7. The LED drive circuit according to claim 1 wherein the current generating circuit has an NPN bipolar transistor whose base is supplied with the output of the constant voltage source, and a PNP bipolar transistor whose base is connected to the emitter of the NPN bipolar transistor, the emitter of the PNP bipolar transistor being connected to the external terminal, and the collector of the PNP bipolar transistor being connected to the current amplifying circuit.

8. The LED drive circuit according to claim 6 wherein the current amplifying circuit has a current mirror circuit including a plurality of NPN bipolar transistors which amplify the current flowing in the collector of the PNP bipolar transistor as reference current to generate the drive current to the LEDs.

9. The LED drive circuit according to claim 2 wherein the output transistors are bipolar transistors.

10. The LED drive circuit according to claim 1 wherein the current generating circuit has an N-channel field effect transistor whose gate is supplied with the output of the constant voltage source, the external terminal being connected to the source of the N-channel field effect transistor, and the current amplifying circuit being connected to the drain of the N channel field effect transistor.

11. The LED drive circuit according to claim 1 wherein the current generating circuit has a P-channel field effect transistor whose gate is supplied with the output of the constant voltage source, and an N-channel field effect transistor whose gate is connected to the source of the P-channel field effect transistor, the source of the N-channel field effect transistor being connected to the external terminal, and the drain of the N-channel field effect transistor being connected to the current amplifying circuit.

12. The LED drive circuit according to claim 11 wherein the current amplifying circuit includes:
a first current mirror circuit including a plurality of P-channel field effect transistor which amplify the current flowing in the drain of the N-channel field effect transistor as reference current; and
a second current mirror circuit including a plurality of N-channel field effect transistor which amplify the output current of the first current mirror circuit as reference current to generate the drive current to the LEDs.

13. The LED drive circuit according to claim 1 wherein the current generating circuit has a P-channel field effect transistor whose gate is supplied with the output of the constant voltage source, the source of the P-channel field effect transistor being connected to the external terminal, and the drain of the P-channel field effect transistor being connected to the current amplifying circuit.

14. The LED drive circuit according to claim 1 wherein the current generating circuit has an N-channel field effect transistor whose gate is supplied with the output of the constant voltage source, and a P-channel field effect transistor whose gate is connected to the source of the N-channel field effect transistor, the source of the P-channel field effect transistor being connected to the external terminal, and the drain of the P-channel field effect transistor being connected to the current amplifying circuit.

15. The LED drive circuit according to claim 13 wherein the current amplifying circuit includes a current mirror circuit having a plurality of N-channel field effect transistors which amplify the current flowing in the drain of the P-channel field effect transistor as reference current to generate the drive current to the LEDs.

16. The LED drive circuit according to claim 2 wherein the output transistors are field effect transistors.

17. The LED drive circuit according to claims 1 wherein the current generating circuit reduces the current to be generated as chip temperature rises.

18. The LED drive circuit according to claim 17 wherein the current generating circuit uses at least one of a current source having a positive temperature coefficient, a negative temperature coefficient the forward voltage of a diode has, a resistor having a positive temperature coefficient and a resistor having a negative temperature coefficient to control the amount of current to be generated.

19. The LED drive circuit according to claim 17 wherein the current generating circuit maintains the amount of current to be generated at a constant level when the chip temperature is equal to or lower than a predetermined temperature.

20. The LED drive circuit according to claim 18 wherein the current generating circuit maintains the amount of current to be generated at a constant level when the chip temperature is equal to or lower than a predetermined temperature.
